(19) United States
(12) Patent Application Publication
(10) Pub. No.: US 2019/0141974 A1
(43) Pub. Date: May 16, 2019

(54) TRANSPARENT FISHING UMBRELLA RIG FOR TROLLING AND CASTING

(71) Applicant: Erik Anderson, West River, MD (US)

(72) Inventor: Erik Anderson, West River, MD (US)

(21) Appl. No.: 16/233,014

(22) Filed: Dec. 26, 2018

Related U.S. Application Data
(63) Continuation of application No. 15/530,382, filed on Jan. 4, 2017.

(51) Int. Cl. A01K 91/053; A01K 85/01; A01K 91/18

(52) U.S. Cl. CPC A01K 91/053; A01K 91/18; A01K 85/01

(57) ABSTRACT

The present invention relates to a transparent fishing umbrella rig for trolling and casting. The transparent fishing umbrella rig for trolling and casting includes a first and second arm. The transparent fishing umbrella can be used in a variety of environments and improves the angler's chance of successfully catching a fish by reducing the visibility of umbrella rig in contrast to the environment and water surrounding the umbrella rig. The transparent fishing rig is assembled by inserting the second arm into the first arm. Both the first arm and second arm have a plurality of lure line connections holes for the angler to connect lure lines and lures to the transparent fishing umbrella rig.

### RELATED APPLICATIONS

This application is a continuation-in-part application of non-provisional patent application U.S. Ser. No. 15/530,382 filed on Jan. 4, 2017, the disclosure of which is hereby incorporated in their entirety at least by reference.

### BACKGROUND

### 1. Field of the Invention

The present invention relates to a transparent fishing rig for trolling and casting.

### 2. Description of Related Art

People have been trying to catch fish for as long as people have known that fish existed. One of man's longest-running challenges has been how to entice a fish to take a baited hook and thus become the fisherman's catch. While a single line and hook has been used with a variety of lures and hooks the search for more efficient fishing tackle and techniques has led to the development of what is known as an umbrella rig. An umbrella rig is typically configured as a device with arms that extend radially from a central point in different directions, with individual lines, hooks, lures and/or bait attached to the extended arms, sometimes at different depths or with different lures and/or bait. Generally, umbrella rigs are made from metal, wire or other materials that are visible in the water and include a plurality of fishing lines extending from the respective wire arms.

The known umbrella rigs currently available have metal and wire structures often scaring fish away and are expensive to manufacture. This is due to the large amount of time and high material cost associated with forming metal and wire umbrella rigs.

### SUMMARY

The present invention solves the problems described above by presenting a substantially transparent umbrella rig that does not draw attention to its structure, but instead is far less visible than current umbrella rigs that can be easily seen in the water. Secondly, the current invention is easier to produce and requires no metal fabrication, wire bending or traditional metal mold pouring.

The transparent fishing umbrella rig provides an improved way to lure fish into biting the lures attached the lure line connections holes of the umbrella rig by reducing the visibility of umbrella rig in contrast to the environment and water surrounding the umbrella rig.

In order to do so, a transparent umbrella rig used for fishing is provided, comprising a first arm having a first top side and a first bottom side; a mainline connection joined to the first top side of the first arm; a central slot arranged within the first arm; a central line connection joined to the first bottom side of the first arm; a first plurality of lure connection holes arranged near the first bottom side of the first arm; a second arm having a second top side and a second bottom side, wherein the second arm passes through the central slot of the first arm; a second plurality of lure connection holes arranged near the second bottom side of second arm, and, an attachment assembly arranged within the second arm, the attachment assembly having a top notch on the second top side of the second arm, a bottom notch on the second bottom side of the second arm, and a deflection slot, wherein the deflection slot allows the second arm to bend to align the top notch and the bottom notch to the central slot of the first arm.

### BRIEF DESCRIPTION OF THE FIGURES

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary perspective view of one embodiment of the transparent fishing umbrella rig.

FIG. 1A shows an exemplary perspective view of one embodiment of the transparent fishing umbrella rig.

FIG. 2A shows an exemplary perspective view of one embodiment of the transparent fishing umbrella rig with a plurality of line releases.

FIG. 2B shows an exemplary perspective view of one embodiment of the transparent fishing umbrella rig with a plurality of line releases holding a lure line tied to the central line connection.

FIG. 2C shows an exemplary perspective view of one embodiment of the transparent fishing umbrella rig with a plurality of line releases after a lure line and lure tied to the central line connection, as shown in FIG. 2B, have been released by the line release.

FIG. 3 shows an exemplary front view of one embodiment of the first arm of the transparent fishing umbrella rig.

FIG. 4 shows an exemplary front view of one embodiment of the first arm of the transparent fishing umbrella rig.

FIG. 5 shows an exemplary front view of one embodiment of the second arm of the transparent fishing umbrella rig.

FIG. 6 shows an exemplary front view of one embodiment of the second arm of the transparent fishing umbrella rig.

FIG. 7 shows an exemplary front view of one embodiment of the second arm of the transparent fishing umbrella rig.

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 0%, 5%, or 10%, including increments therein.

Unless otherwise defined, all technical terms used herein have the same meaning as commonly understood by one of ordinary skill in the art to which this disclosure belongs.

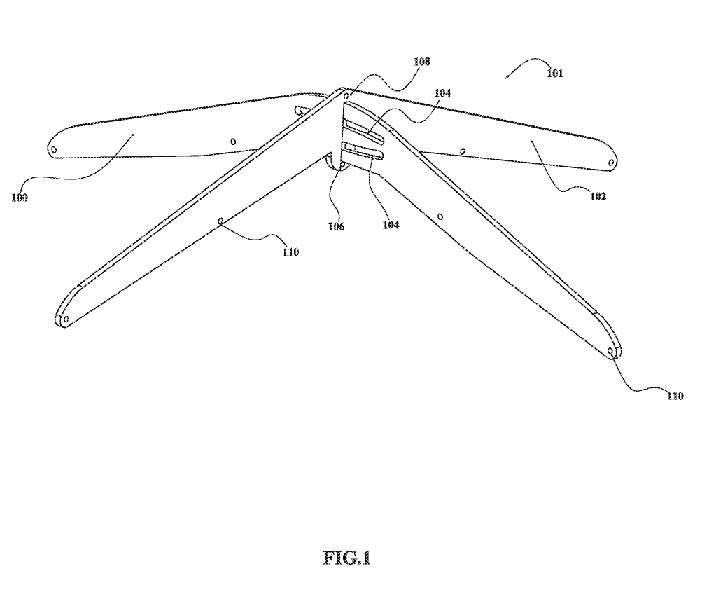

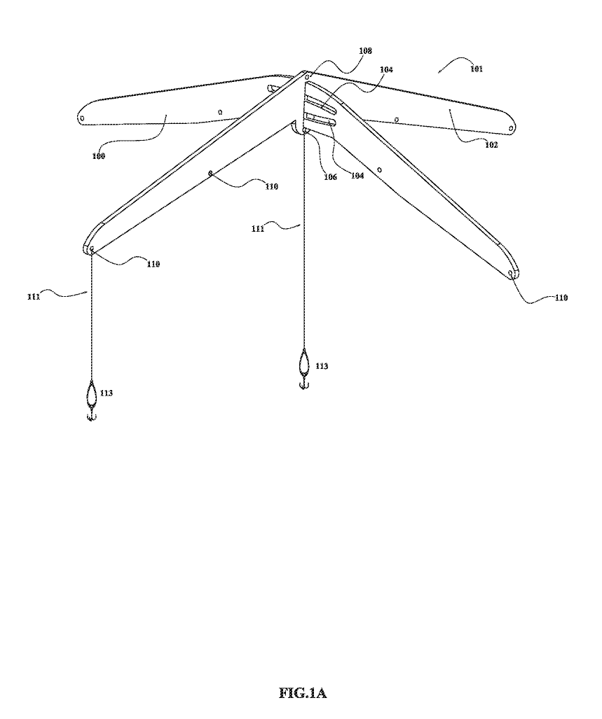

FIG. 1 shows an exemplary perspective view of one embodiment of the transparent fishing umbrella rig 101. The exemplary transparent fishing umbrella rig 101 includes the first arm 102 having a first top side and a first bottom side and having a central slot 105, a mainline connection 108 of the first top side, a first plurality of lure connection holes 110 and a central line connection 106 on the first bottom side. The current exemplary embodiment of the transparent fishing umbrella rig 101 also includes a second arm 100 having a second top side, a second bottom side, a second plurality of lure connection holes 110 and having an attachment assembly. The attachment assembly comprising of: at least one deflection slot 104, a top notch 115 on the second top side of the second arm 100 and a bottom notch 114 on the second bottom side of the second arm 100. The current embodiment of the transparent fishing umbrella rig 101 comes disassembled. The user assembles the transparent fishing umbrella rig 101 by inserted the second arm 100 into the central slot 105 of the first arm 102. The second arm 100 then bends or deflects due to the placement of the deflection slot 104 to allow the top notch 115 and the bottom notch 114 to align with the central slot 105 of the first arm 102.

In the current embodiment shown in FIG. 1, the transparent fishing umbrella rig 101 has two deflection slots 104. In some embodiments, the transparent fishing umbrella rig 101 can have at least one deflection slots. In some embodiments, the material used to make the first arm 102 or the second arm 100 can have a higher elasticity module, consequently, the second arm 100 in some embodiments can have no deflection slots 104. The central slot of the first arm 102 is currently an exemplary shape of a rectangle with a width the thickness of the material used to make the second arm 100. The user or angler attaches the mainline to the mainline connection 108 on the first top side of the first arm 102. In some embodiments, the mainline connection 108 is a swivel. The angler then may tie a series of lure lines 11 to a series of lures 113 to the plurality of lure connection holes 110 on both the first arm 102 and the second arm 100. The first arm 103 and the second arm 100 separate out the lure lines 111 and respective lures 113 from becoming intertangled. In some embodiments, the central line connection 106 is a swivel.

The material used to construct the transparent fishing umbrella rig 101 can be at least member of a material set consisting of: a transparent acrylic plastic, a transparent polycarbonate plastic, a transparent Butyrate (cellulose acetate butyrate) plastic, a PETG (glycol-modified polyethylene terephthalate) or any other transparent material sheet known to one skilled in the art.

FIG. 1A shows an exemplary perspective view of one embodiment of the transparent fishing umbrella rig with multiple lure lines 111 attached to the central line connection 106 and one of the plurality of lure connection holes 110. In some embodiments, the plurality of lure connection holes 110 further comprises a plurality of swivels attached to the plurality of lure connection holes 110, in which case the lure line 111 attaches to the swivel instead of the lure connection holes 110.

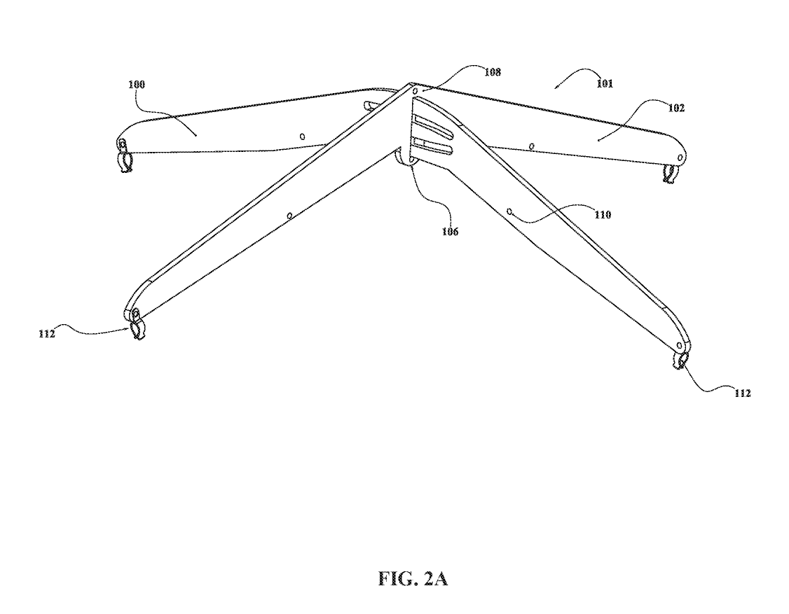

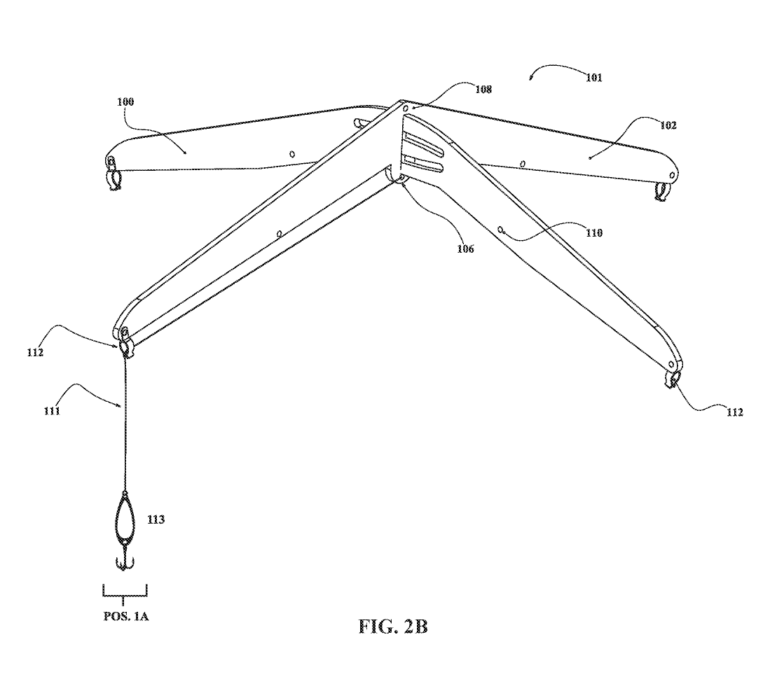

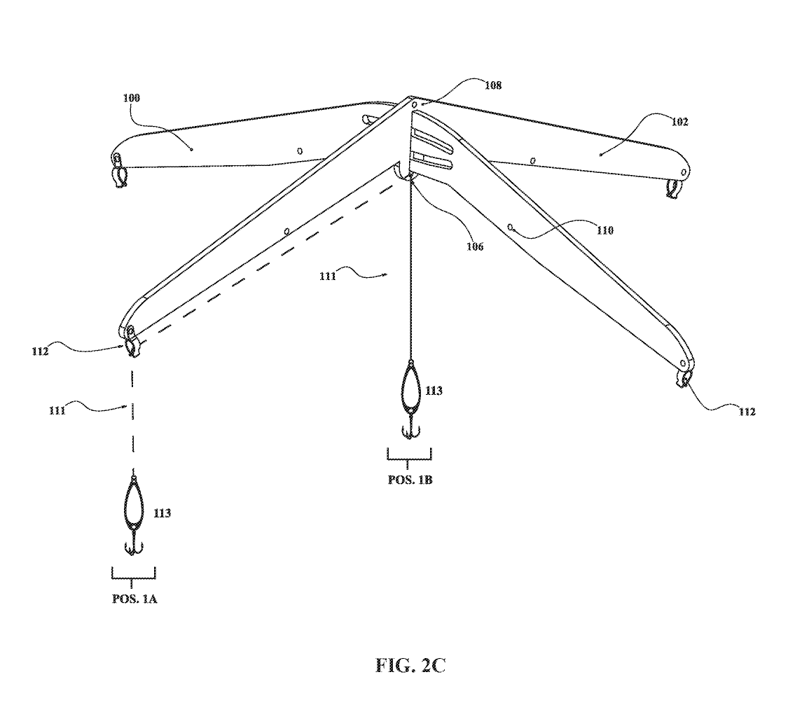

FIGS. 2A-C show an exemplary perspective view of one embodiment of the transparent fishing umbrella rig 101 with a plurality of line releases 112. FIG. 2B shows an exemplary perspective view of one embodiment of the transparent fishing umbrella rig with a plurality of line releases 112 holding a lure line 111 and lure 113 tied to the central line connection 106. In some embodiments, the lure line release 112 temporally holds the lure line 111 and lure 113 away from other lure lines 111 and lures 113 in POS 1A. FIG. 2C shows an exemplary perspective view of one embodiment of the transparent fishing umbrella rig with a plurality of line releases 112 after the lure line 111 and lure 113, tied to the central line connection 106 have been released by the lure line release 112 to POS 1B. When tension is applied to the lure line 111 and lure 113, the lure line 111 slips through the lure line release 112 and extends to POS 1B. In some embodiments, lure lines 111 are not tied to the central line connection 106, but are rather tied to another lure connection hole 110 on the first arm 102 or second arm 100.

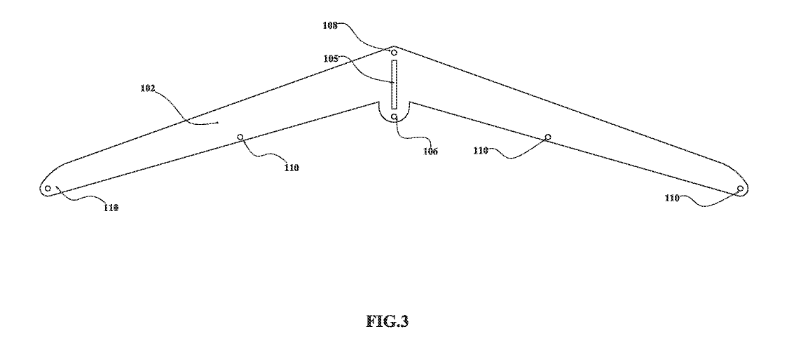

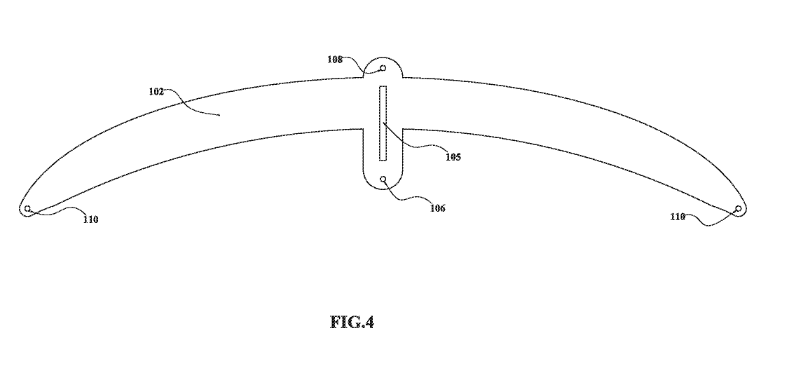

FIG. 3 shows an exemplary front view of one embodiment of the first arm 102 of the transparent fishing umbrella rig 101. As shown in FIG. 3, the first arm 102 in the current exemplary embodiment comprises straight edges. FIG. 4 shows an exemplary front view of one embodiment of the first arm 102 of the transparent fishing umbrella rig 101. As shown in FIG. 4, the first arm 102, in some embodiments, can comprise of a convex or concave arm shape. In some embodiments, the distance between the center of the mainline connection 108 and any center of the plurality of lure connection holes 110 is greater than the distance between the center of the mainline connection 108 and the center of the central line connection 106. In some embodiments, the distance between the center of the mainline connection 108 and any center of the plurality of lure connection holes 110 is less than the distance between the center of the mainline connection 108 and the center of the central line connection 106.

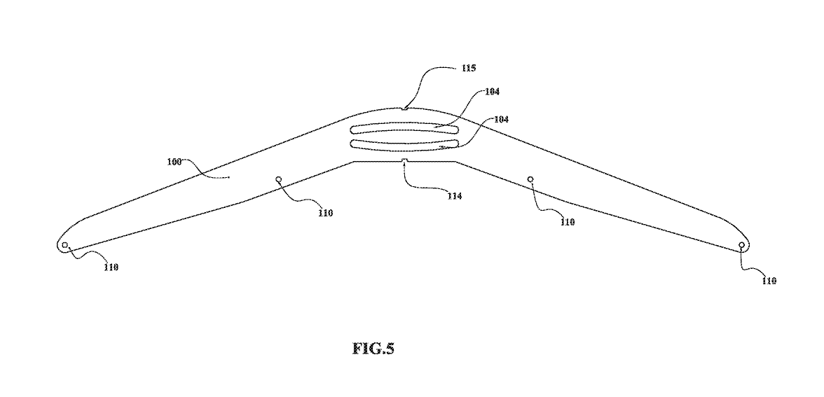

FIG. 5 shows an exemplary front view of one embodiment of the second arm 100 of the transparent fishing umbrella rig 101. The deflection slots 104 are shown in FIG. 5 by which the second arm 100 material deflects to allow the top notch 115 and the bottom notch 114 of the attachment assembly to align with the central slot 105 of the first arm 102. As shown in FIG. 5, in the current exemplary embodiment the second arm 100 comprises straight edges. In some embodiments, the second arm 100 can comprise of a convex or concave arm shape.

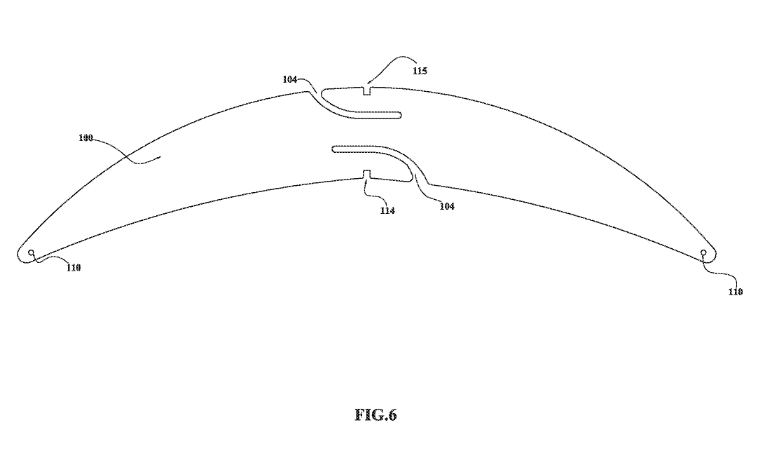

FIG. 6 shows an exemplary front view of one embodiment of the second arm 100 of the transparent fishing umbrella rig 101. In this embodiment, the deflection slot 104 is an extension of the perimeter edge of the second arm 100. This embodiment of the deflection slots 104 creates a portion of the second arm 100 into two cantilever arms having one end fixed and one end free to deflect. The resultant deflection allows for the second arm 100 material to deflect, therefore allowing the top notch 115 and the bottom notch 114 to align with the central slot 105 of the first arm 102.

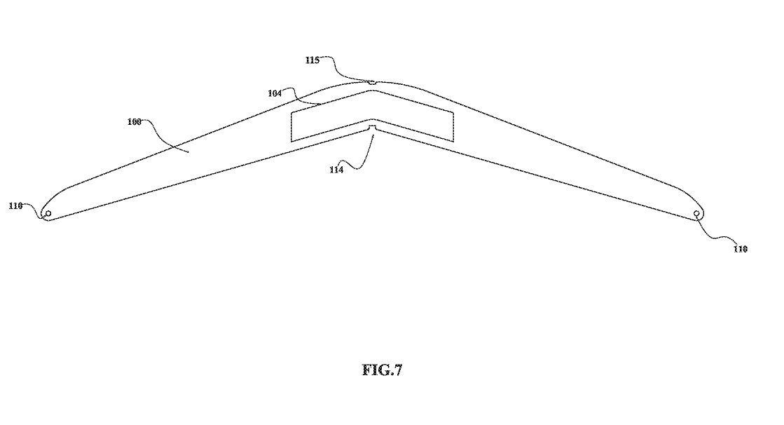

FIG. 7 shows an exemplary front view of one embodiment of the second arm 100 of the transparent fishing umbrella rig 101. In this embodiment, the deflection slot 104 is a singular slot allowing for deflection of the second arm 100 material to deflect above and below the singular slot. The resultant deflection from the singular slot allows for the second arm 100 material to deflect, therefore allowing the top notch 115 and the bottom notch 114 to align with the central slot 105 of the first arm 102.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Any element in a claim that does not explicitly state “means for” performing a specified function, or “step for” performing a specified function, is not to be interpreted as a “means” or “step” clause as specified in 35 U.S.C. § 112, 6. In particular, any use of “step of” in the claims is not intended to invoke the provision of 35 U.S.C. § 112, 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A transparent umbrella rig used for fishing, comprising:
a first arm having a first top side and a first bottom side,
a mainline connection joined to the first top side of the first arm;
a central slot arranged within the first arm;
a central line connection joined to the first bottom side of the first arm;
a first plurality of lure connection holes arranged near the first bottom side of the first arm;
a second arm having a second top side and a second bottom side, wherein the second arm passes through the central slot of the first arm;
a second plurality of lure connection holes arranged near the second bottom side of second arm; and,
an attachment assembly arranged within the second arm, the attachment assembly having a top notch on the second top side of the second arm, a bottom notch on the second bottom side of the second arm, and a deflection slot, wherein the deflection slot allows the second arm to bend to align the top notch and the bottom notch to the central slot of the first arm.

2. The umbrella rig of claim 1, wherein the first top side of the first arm is made as one shape of a shape set including: a straight shape, a concave shape and a convex shape.

3. The umbrella rig of claim 1, wherein the first bottom side of the first arm is made as one shape of a shape set including: a straight shape, a concave shape and a convex shape.

4. The umbrella rig of claim 1, wherein the second top side of the second arm is made as one shape of a shape set including: a straight shape, a concave shape and a convex shape.

5. The umbrella rig of claim 1, wherein the second bottom side of the second arm is made as one shape of a shape set including: a straight shape, a concave shape and a convex shape.

6. The umbrella rig of claim 1, wherein the attachment assembly further comprises a plurality of deflection slots.

7. The umbrella rig of claim 1, wherein the mainline connection is a swivel.

8. The umbrella rig of claim 1, wherein the central line connection is a swivel.

9. The umbrella rig of claim 1, wherein the first plurality of lure connection holes further comprises a swivel.

10. The umbrella rig of claim 1, wherein the second plurality of lure connection holes further comprises a swivel.

11. The umbrella rig of claim 1, further comprising a plurality of a line releases joined to at least one of the lure connection holes of the first plurality of lure connection holes, wherein a fishing line is tied to the central line connection of the first arm and fed through the line release.

12. The umbrella rig of claim 1, further comprising a plurality of a line releases joined to at least one of the lure connection holes of the second plurality of lure connection holes, wherein a fishing line is tied to the central line connection of the first arm and fed through the line release.
